(19) United States
(12) Patent Application Publication
(10) Pub. No.: US 2025/0013503 A1
(43) Pub. Date: Jan. 9, 2025

(54) UNIVERSAL API STANDARD AND HUB FOR CLOUD INTEROPERABILITY

(71) Applicant: Anantyx LLC, Reston, VA (US)

(72) Inventors: Paul SHULMAN, Reston, VA (US); Konstantin GIRKHOVSKIY, Reston, VA (US)

(73) Assignee: Anantyx LLC, Reston, VA (US)

(21) Appl. No.: 18/394,439

(22) Filed: Dec. 22, 2023

Related U.S. Application Data
(60) Provisional application No. 63/512,449, filed on Jul. 7, 2023.

(51) Int. Cl. G06F 9/50; G06F 9/54

(52) U.S. Cl. CPC G06F 9/5072; G06F 9/541

(57) ABSTRACT

Methods and systems for creating a universal API standard for communication and operability between brand-specific cloud services. A method for enabling a developer to execute a standardized API call to access, monitor and manage cloud services provided by multiple distinct cloud computing systems is disclosed. The method includes accepting, via an API gateway of a cloud-connected system, an external API call, queuing, via a queueing engine of the cloud-connected system, the external API call for processing, and converting, via a transformation and communication engine of the cloud-connected system, a message of the external API call into a brand-specific API call format. A response to the brand-specific API call flows through a same path in an opposite direction.

### CROSS-REFERENCES TO RELATED APPLICATIONS

This application claims the benefit of U.S. Provisional Patent Application No. 63/512,449, filed on Jul. 7, 2023, which is incorporated by reference herein in its entirety.

### FIELD OF THE DISCLOSURE

The present disclosure generally relates to the technical field of cloud computing services.

### BACKGROUND OF THE DISCLOSURE

Application Programming Interfaces (APIs) offered by cloud providers lack both uniformity and a common messaging structure, and, in many cases, require the use of individual service-specific toolkits. Cloud providers regularly release new services that can include specific languages and interfacing requirements. These services are often accompanied by newly released API toolkits that multiply in number and complexity with the advances of cloud platforms. This progressive rollout of services makes programmatic integration with cloud services difficult, cumbersome, and time consuming. The complexity involved in cloud service interfacing can be further multiplied through the use of multiple cloud services by a single entity. As a result, the need for standardization throughout the cloud-computing industry has increased accordingly to address these issues. The present lack of standardization can slow productivity, limit the use of cloud services, and can reduce the realization of cloud benefits.

Further, cloud service use can be hampered due to both the limitations and disparities of various clouds' API data models. These issues are not limited to cross-platform services, as cloud services that are offered by the same cloud provider often require the use of individual, service-specific toolkits. Such an approach slows down innovation and ability of software developers to rapidly develop on newly released cloud services, with a barrier to entry in place for each new service. The challenge is further increased for frameworks incorporating multiple cloud services or cloud providers, such that the benefits of these cloud services cannot be fully realized. Even previously-released toolkits continue to be developed and enhanced, introducing further modifications with require mirroring these modifications in any third-party software attempting to utilize these toolkits.

### SUMMARY OF THE DISCLOSURE

The present disclosure relates to API calling within cloud computing services, and, more particularly, describes methods and systems utilizing a universal API standard for managing cloud computing services.

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure a method of enabling developers to develop on top of a plurality of cloud services provided by multiple distinct cloud computing systems includes receiving, via an application programming interface (API) gateway of a cloud-connected system, an initial API call and a target cloud service, determining, via a universal API hub of the cloud-connected system, brand-specific API formatting for the target cloud service, transforming, via a transformation and communication engine of the cloud-connected system, the initial API call into a brand-specific API call using the brand-specific API formatting, and communicating, via the transformation and communication engine, the brand-specific API call to the target cloud service.

In another embodiment, a cloud-connected system for accessing cloud services provided by multiple distinct cloud computing systems includes a processor, and a storage device communicatively coupled to the processor, wherein the storage device is configured to store computer-executable instructions. The computer-executable instructions, when executed by the processor, cause the processor to receive, via a web server, one or more initial application programming interface (API) calls and one or more target cloud services from one or more user devices/client application servers, pass the initial API calls from the web server to an API gateway, transform, via a transformation and communication engine, the initial API calls into brand-specific formats of the target cloud services, store the one or more transformed API calls in an entry of a database in communication with the universal API hub, and call, via the transformation and communication engine, the target cloud services using the transformed API calls.

In a further embodiment, a method of adding further microservices to a cloud-connected system for accessing cloud services provided by multiple distinct cloud computing systems includes receiving, from a developer user, API call translation information for a new cloud provider and/or a new cloud service of an existing cloud provider, identifying, via the cloud-connected system, the cloud brand and the cloud service of the API call translation information, and establishing a new microservice of a transformation and communication engine for the cloud service with instructions for transformation of API calls using the API call translation information.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a block diagram of an example cloud-connected system including a multi-cloud interoperability hub for communication with a plurality of cloud services.

FIG. 2 is a block diagram of the transformation and communication engine of the cloud-connected system for interfacing with a plurality of cloud services.

FIG. 3 illustrates an example universal API format for use within the multi-cloud interoperability hub.

FIG. 4 is an example of a method for receiving, transforming, and communicating an initial API call to a target cloud service using a universal API format.

FIG. 5 is an example of a method for communicating an initial API call to a target cloud service and returning an API call response to the source using a universal API format.

FIG. 6 is an example of a method for adding a new microservice to a transformation and communication engine for further use by user devices/client application servers using a universal API format.

### DETAILED DESCRIPTION

The present disclosure generally relates to API calling within cloud services, and, more particularly, to methods and systems utilizing a universal API standard for managing cloud services. The inventors recognized that what is needed is a standardized format, method, and system for universally communicating with various cloud services and cloud providers, particularly via an developer for developing on top of a plurality of cloud services.

The systems and methods disclosed herein can enable developers to develop on top of a plurality of cloud services using a universal format that can be translated for use in any cloud service brand-specific format. The systems and methods can include the use of an user client application or secure web browser portal for making requests to a plurality of cloud services and cloud providers. The received requests can be converted on a web server, presentation layer, and REST API gateway to be processed via a universal API hub. The systems and methods can include identifying a target cloud brand and assigning transformation and communication of the API call to a microservice created specifically for translation of the universal API format into the brand-specific format. The microservices can handle both the transformation of the API call and the interfacing/communication with the target cloud service, such that all brand-specific operations are handled within the microservices. As such, the remainder of the systems and methods are universally usable for any desired cloud service or brand. The systems and methods can further include receiving and translating a response message from the cloud service back into a universal format. The universally formatted response message can then be provided back through the system to reach the user client application or secure web browser portal in the universal format, such that the client application or secure web portal can display a result/message to the user device/client application server from the target cloud service.

In some embodiments, the systems and methods disclosed herein can utilize queueing engines or message queues for asynchronous messaging and real-time performance of API calls based upon priority and importance of the desired operation. The systems and methods disclosed herein can include storing state information of each API call transaction within a multi-cloud interoperability hub database, such that the active API calls can be monitored, tracked, and identified. The embodiments disclosed herein can include systems and methods for adding translation information of new cloud services or cloud brands to new microservices, such that the multi-cloud interoperability hub can utilize a plug-and-play nature for the microservices. In this way, the majority of the infrastructure for the multi-cloud interoperability hub is agnostic to the target cloud service, and can instead be a universal hub for any desired API call.

The systems and methods described herein can enable quicker and simpler implementation of cloud services for a client application or secure web browser portal without the need for specialized knowledge or experience with the desired cloud services. Through the universality of the multi-cloud interoperability hub, the client application or secure web browser portal can generate API calls for any desired cloud services using the same workflow. Developer users can modify and create microservices for the implementation of new services within the multi-cloud interoperability hub without affecting an end user experience. The universal API format can enable a unified approach to the translation into brand-specific formats, and the same information can be utilized in a plurality of cloud service API calls. The evolving nature of the multi-cloud interoperability hub can enable constant updating and changing of cloud providers and cloud services without the barrier of entry that is re-learning the API language and workflow.

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

### System

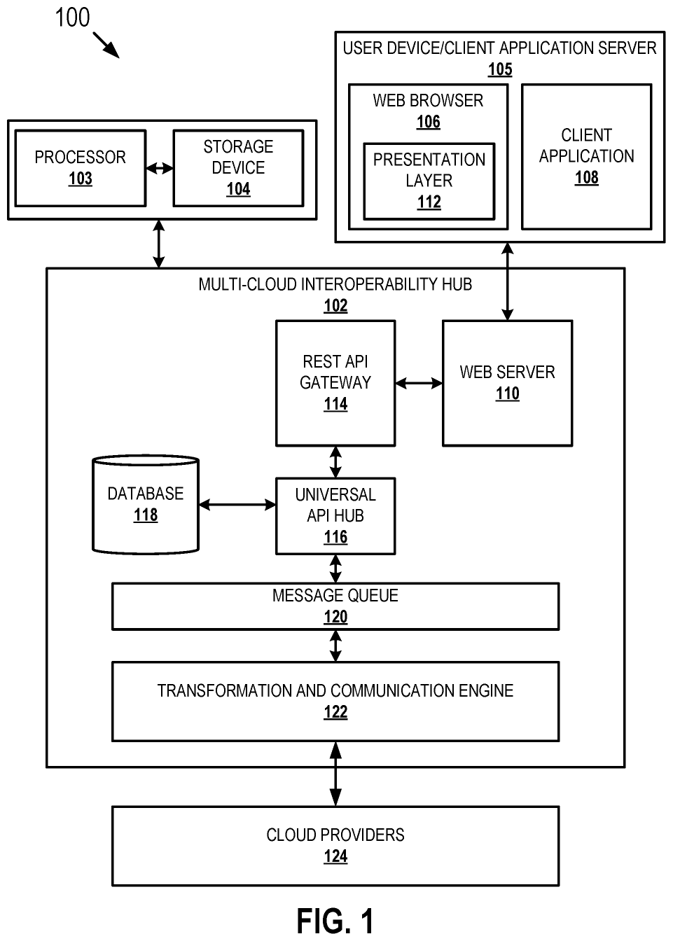

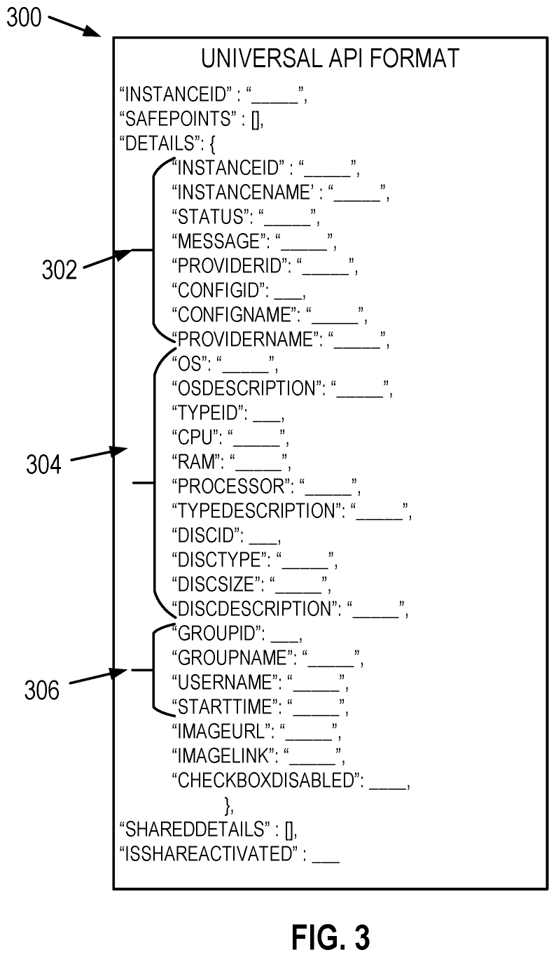

FIG. 1 is a block diagram of an example cloud-connected system 100 including a multi-cloud interoperability hub 102 for communication with a plurality of cloud services. Cloud-connected system 100 can include, or be otherwise coupled to, a processor 103 and a storage device 104. Storage device 104 can include executable instructions that can be performed by the processor 103 to carry out one or more tasks of the cloud-connected system 100 or the multi-cloud interoperability hub (hereinafter, “MCIH”) 102. In some embodiments, processor 103 further receives executable instructions from the MCIH 102 to perform desired functions. The cloud-connected system 100 can further include, or be in communication with, a user device/client application server 105, through which a user can access and utilize the MCIH 102. User device/client application server 105 can include a web browser 106 or a client application 108 stored thereon, such that the user can interface with the MCIH 102 through one or more means. Web browser 106 can enable connection to a web server 110 of the MCIH 102 via a presentation layer 112 of either the user device/client application server 105 or the web server 110, wherein a graphical user interface (GUI) can be generated and presented to a user. Similarly, client application 108 can be a third-party application on a server (e.g., user device/client application server 105) and can be integrated with, and can call, the MCIH 102 to provide a dedicated access portal to web server 110 with a built-in GUI to enable access to MCIH 102. User device/client application server 105 can accordingly be enabled by developers to select one or more cloud services to initiate or modify via MCIH 102, via either web browser 106 or client application 108. Both the web page accessed through web browser 106 and client application 108 can generate an API call via an input from an end user of the user device/client application server 105. The API calls generated from the user device/client application server 105 can be provided to web server 110 in a universal API language or format that provides all relevant information required by the target cloud service, such that it can later be converted into a brand-specific format without the need for advanced knowledge of this format (see FIG. 3).

MCIH 102 can be any type of online platform including, but not limited to, a software as a service (SaaS) or other platform. MCIH 102 and its connected components (processor 103, storage device 104) can be implemented on one or more servers at the same or different locations. MCIH 102 can be implemented using one or more application programming interfaces (APIs) as needed to access different services to perform operations as described herein. MCIH 102 can be communicatively coupled to one or more web servers supporting World Wide Web services, communication protocols, or standards.

Processor 103 can use a single, dual, or other multi-processor architecture. Processor 103 can include one or more of a microprocessor, a microcontroller, an embedded processor, a digital signal processor (DSP), a central processing unit (CPU), a graphics processing unit (GPU), a neural processing unit (NPU), a vision processing unit (VPU), a field-programmable gate array (FPGA), a quantum processor, an application-specific integrated circuit (ASIC), or other like units for processing computer-executable (e.g., machine-readable) instructions.

Storage device 104 employ any computer-executable or-readable medium, and any computer-executable or-readable storage medium known now or in the future. Examples of computer-executable or computer-readable mediums include, but are not limited to, primary storage devices (e.g., any type of random-access memory (RAM), secondary storage devices (e.g., hard drives, floppy disks, compact disc-read only memory (CD-ROM), tapes, magnetic storage devices, optical storage devices, micro-electromechanical systems (MEMS), nano-technological storage devices, solid-state drives, flash memory, read-only memory (ROM), memory cards, secure digital (SD) cards, etc.), and communication mediums (e.g., wired and wireless communications networks, local area networks (LANs), wide area networks (WANs), intranets, etc.). Computer-executable or computer-readable mediums can include any form of transitory (which include signals) or non-transitory (which exclude signals) media. Non-transitory media comprise, by way of a non-limiting example, the aforementioned physical storage devices (e.g., primary and secondary storage devices).

User device/client application server 105 can be any type of computing device including, but not limited to, a smartphone, laptop, desktop, tablet, workstation, or other computing device having at least a processor and a computable-readable memory. The computing device can have an operating system as would be apparent to a person skilled in the art given this description. The computing devices can include integrated display devices or can be communicatively coupled to the display device. The display device can display web browser 106 or client application 108, for example. Web browser 106 can be any type of browser including, but not limited to, a SAFARI browser from APPLE INC, CHROME browser from GOOGLE LLC or EDGE browser from MICROSOFT INC. Client application 108 can be a standalone application or can operate as a web application within web browser 106. For example, client application 108 can be downloaded by a user from an application store or other site. Similarly, the presentation layer 112 can be accessed by directing the web browser to a portal page or other entry page allowing the user to access MCIH 102. For clarity, the term online application is used to refer to either client application 108 or a web application supported by web browser 106. In further embodiments, however, the client application 108 can be an internet of things (IoT) device application, a server which does not present itself online, or any other isolated or offline format.

Network interfaces (not shown) can provide logical connections for one or more remote computing devices to connect to a public or private network. The networks can be a LAN, WAN, or the internet, for example. Network interfaces can include one or more of a modem, a router, a network interface card (NIC), an access point, a switch, computer-executable instructions, other like components for providing logical connections to a network, or a combination thereof. Network interfaces can be internal or external to the computing devices communicating via the logical connections. One or more computing devices can be coupled to network interfaces via a wired connection (e.g., Ethernet) or a wireless connection (e.g., Wi-Fi).

Web server 110 can serve as a communication point between the MCIH 102 and the user device/client application server 105 for facilitating operations of the MCIH 102. In some embodiments, processor 103 and storage device 104 can be included within web server 110, such that the web server directly receives and executes the instructions for the MCIH 102. In further embodiments, however, web server 110 can be in communication with an external processor 103 and storage device 104 for performance of one or more tasks. Web server 110 can directly pass messages, API calls, and further information directly to a REST API gateway 114 through a communicative coupling therebetween. The REST API gateway 114 can receive the various API calls and messages from the web server 110 and can manage the facilitation of each call and message through the MCIH 102.

REST API gateway 114 can pass these messages and API calls through to the universal API hub 116 of the MCIH 102. Universal API hub 116 can receive the messages and API calls, and can store state information related thereto within a connected database 118. Database 118 can be updated with a current state of each API call or message from a plurality of user devices/client application servers 105 and corresponding to a plurality of cloud services. As calls are communicated and responses are received to messages, universal API hub 116 can provide updated state information to database 118 while also passing the response back through the REST API gateway 114. In some embodiments, universal API hub 116 can receive the API call or message and can determine the corresponding target cloud service, as well as the priority of the API call or message.

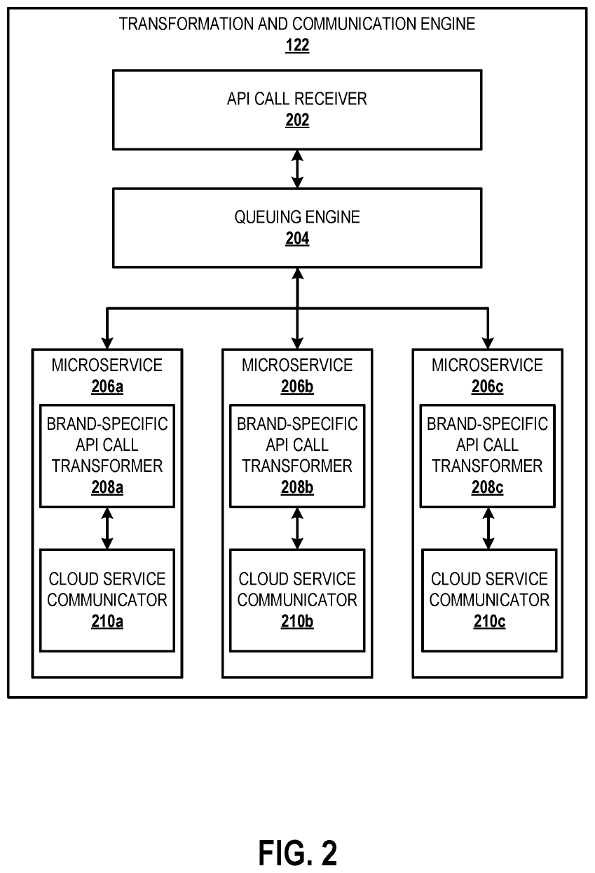

Universal API hub 116 can be in further communication with a message queue 120, which can receive messages and API calls from the universal API hub 116 as well as priority or timing information. Message queue 120 can accordingly maintain a queue of API calls and response messages to be processed within the MCIH 120. Message queue 120 can thus enable asynchronous messaging for non-essential calls and messages, while enabling event stream-processing for priority matters. Message queue 120 can be in further communication with a transformation and communication engine 122, which can handle all translation of API calls and messages as well as any communication with the cloud providers 124 which can be handled via the MCIH 102. As shown in FIG. 2, transformation and communication engine 122 can include a plurality of microservices (206a-c of FIG. 2), each of which correspond to a target cloud service of a specific cloud provider 124.

Cloud providers 124 can provide on-demand, scalable computing resources, such as computer processing, data storage, applications over the internet, or the like. Cloud providers 124 can be any cloud-service providers (CSPs), IT companies, or other like businesses providing on-demand, scalable computing resources including, but not limited to, GOOGLE CLOUD, MICROSOFT AZURE, AMAZON WEB SERVICES (AWS). Cloud providers 124 can provide services such as infrastructure as a service (IaaS), SaaS, platform as a service (PaaS), or other like IT services.

Transformation and communication engine 122 can receive the API call or message in a universal format with a denoted target cloud service, and can provide the API call or message to the corresponding microservice. The microservices of the transformation and communication engine 122 can convert the universal API format into the brand-specific API format of the target cloud service via pre-determined API call translation information built into the microservice. Transformation and communication engine 122 can thus extract the necessary information from the universally formatted API call or message to correctly prompt the cloud provider 124 and target cloud service. Transformation and communication engine 122 can further facilitate the connection or communication between the MCIH 102 and the cloud providers 124, as the transformed API call can be directly provided to the cloud providers 124 via an interface of each microservice.

Cloud providers 124 in communication with the cloud-connected system 100 and the MCIH 102 can accordingly process the transformed API call and affect the desired change or perform the desired operation. Following execution of the transformed API call, cloud providers 124 can return a response message to transformation and communication engine 122, universal API hub 116, or message queue 120. In some embodiments, the response message is provided to universal API hub 116, the sending cloud service can be determined, and the response message can be queued for transformation within message queue 120. In further embodiments, the microservice of transformation and communication engine 122 which provided the initial API call or message to cloud providers 124 can directly receive the response message. In these embodiments, the microservice of transformation and communication engine 122 can translate the brand-specific formatting of the response message back into a universal API format.

Regardless of the path of the received response message from cloud providers 124, transformation and communication engine 122 can provide the universally translated response message back through the MCIH 102. Message queue 120 can be utilized in queueing the response message based upon priority and time of receipt, such that critical responses can be provided ahead of further API calls or confirmation messages. The universally translated response message can be provided to universal API hub 116 and database 118 for updating of the state information therein. Universal API hub 116 can utilize database 118 to determine the target user device/client application server 105 which is to receive the response message, corresponding to the initial API call. Universal API hub 116 can further provide the universally translated response message to REST API gateway 114 for facilitating passage of the message through the web server 110. Web server 110 can thus provide the universally translated response message to the user device/client application server 105, via either the web browser 106 or the client application 108. The GUI provided via the web browser 106 or the client application 108 can present the pertinent information of the universally translated API call response message to the user or client application 108 to close the loop of the API call or message.

### Transformation and Communication Engine

FIG. 2 is a block diagram of the transformation and communication engine 122 of the cloud-connected system 100 (see FIG. 1) for interfacing with a plurality of cloud services. The transformation and communication engine 122 can include an API call receiver 202 for receiving and facilitating passage of API calls and messages therethrough. In some embodiments, the API call receiver 202 can determine the target cloud service if not previously determined within the MCIH 102 of FIG. 1. In further embodiments, however, API call receiver 202 can receive the target cloud service as part of the API call or message, and can utilize this information in the processing of the API call or message. Transformation and communication engine 122 can include its own queuing engine 204 that can be utilized in queueing a plurality of API calls or messages to be passed to one or more microservices 206a-c. Queueing engine 204 can maintain a plurality of queues corresponding to each microservice 206a-c, such that multiple microservices 206a-c can be accessed and utilized simultaneously while maintaining a backlog for each microservice 206a-c.

Each of the microservices 206a-c can include at least two components to facilitate operation of the transformation and communication engine 122. The microservices 206a-c can each include a unique brand specific API call transformer 208a-c which can include API call translation information for both translation directions. For example, a brand specific API call transformer 208a-c can receive a universally translated API call for transformation into a brand specific API call, or can receive a brand specific API response message for transformation back into a universally translated API response message. The brand-specific API call transformers 208a-c can each be coupled to a cloud service communicator 210a-c of the microservices 206a-c. The cloud service communicators 210a-c can provide direct communication between the transformation and communication engine 122 (as well as the MCIH 102 of FIG. 1) and the target cloud service of each API call. In some embodiments, the cloud service communicators 210a-c can receive the response messages from the cloud services in response to a passed API call. In further embodiments, however, the cloud service can provide the response to the API call receiver 202 for queuing and processing via a microservice 206a-c. While the transformation and communication engine 122 of FIG. 2 shows only three microservices 206a-c, any number of microservices 206a-c can be included therein for communication with any and all available cloud services and cloud providers. Accordingly, transformation and communication engine 122 can enable user devices/client application servers to utilize the MCIH 102 to communicate with any desired target cloud services without expertise or advanced knowledge of the cloud service's unique toolkit and API format.

### Universal API Format

FIG. 3 illustrates an example universal API format 300 for use within the multi-cloud interoperability hub 102 (see FIG. 1). Universal API format 300 can be utilized to create an API call for any number of target cloud services that utilize a brand-specific format. Accordingly, universal API format 300 includes all relevant information needed by the various target cloud services to generate the brand-specific format for an API call. Universal API format 300 can include additional information not utilized by the target cloud service, such that the same universal API format 300 can be used for a variety of cloud services without needing to adjust the types of information stored within the universal API format 300.

Universal API format 300 can include general identifying information 302, such that the API call can be referenced and stored within a database (e.g., the database 118) for later searching and updating. Identifying information 302 can include an ID and name for the instance, the status of the instance, the message of the corresponding API call, the name and ID of the cloud provider, and the name and ID of the configuration used. The universal API format can further include hardware information 304 for the requested operation. Hardware information 304 can include a target operating system, a description of the operating system, an ID and description of the target system type, the number and type of CPUs, the amount of RAM, and the ID, type, size, and description of the disc to for the hardware. Further, universal API format 300 can include user device/client application server information 306 including the ID and name of the group performing the API call, the username accessing the user device/client application server, the start time of the API call, and any further identifying or relevant information for the API call transaction.

### Methods of Operation

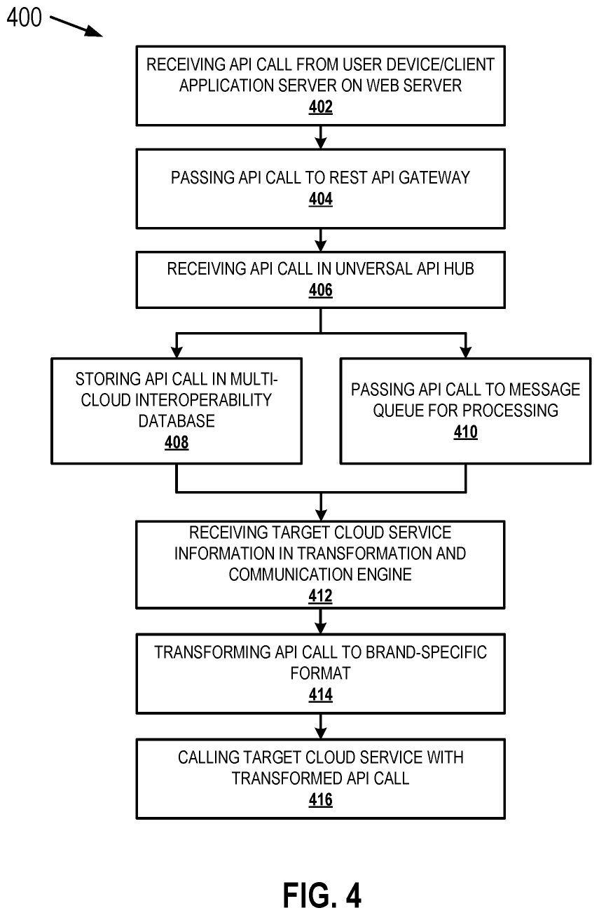

In view of the structural and functional features described above, example methods will be better appreciated with reference to FIGS. 4-6. While, for purposes of simplicity of explanation, the example methods of FIGS. 4-6 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions can be performed that are omitted from the description.

FIG. 4 is an example of a method 400 for receiving, transforming, and communicating an initial API call to a target cloud service using a universal API format. The method 400 can be implemented by the cloud-connected system 100, as shown in FIG. 1. Thus, reference can be made to the example of FIGS. 1-3 in the example of FIG. 4. The method 400 can begin at 402 by receiving an API call from a user device/client application server on a web server (e.g., the web server 110) of a multi-cloud interoperability hub (e.g., the MCIH 102). The API call can be passed to the web server through the user device/client application server (e.g., the user device/client application server 105) via either an installed client application (e.g., the client application 108) or through a web portal provided on a web browser (e.g., the web browser 106) via a presentation layer (e.g., the presentation layer 112). The web server can receive the API call in a universal format generated via the client application or web portal, such that each incoming API call and request utilizes the same format and structure of identifying information. While method 400 specifically covers the flow of a single API call from a single user device/client application server, receiving an API call at 402 can be performed by any number of user devices/client application servers simultaneously requesting from any number of cloud services.

Method 400 can continue at 404 with passing the API call to a REST API gateway (e.g., the REST API gateway 114) for efficient, secure, and simple management of any number of API calls. The REST API gateway can route the requests, API calls, and messages to a desired target, and can aid in interfacing between the web server and the additional components of the MCIH. Method 400 can further include receiving the API call in the universal API hub (e.g., the universal API hub 116) of the MCIH at 406. The universal API hub can receive a plurality of API calls and facilitate storage and processing of the API calls and destinations. In some embodiments, the universal API hub can determine a target service for each API call and can prepare proper flagging or routing to ensure the API call is passed to a correct microservice (e.g., the microservices 206a-c).

Accordingly, method 400 can continue at 408 with storing the API call, any identifying information, and a state of the transaction within a database (e.g., the database 118) of the MCIH. The database can be later utilized in determination of a target user device/client application server for a message response, querying of API call status, and logging for audit or performance assessment. The method 400 can simultaneously, or subsequently, include passing the API call to a message queue (e.g., the message queue 120) for processing at 410. The message queue can receive a plurality of API calls, as well as information on priority requests, and can provide timing and order information for each API call to be performed. For priority requests, the queueing engine can enable real-time event processing as the API call is instantly passed forward to the target cloud service. In contrast, requests of lower importance can be queued for delayed execution and asynchronous messaging, such that priority requests can advance ahead of those of lower importance.

Method 400 can continue at step 412 with receiving target cloud service information within a transformation and communication engine (e.g., the transformation and communication engine 122). The target cloud service information can be utilized at 412 in determining a microservice of the transformation and communication engine to receive and handle the transformation of the API call into the desired brand-specific format. Accordingly, method 400 can continue at step 414 with transforming the API call into the brand-specific format for the target cloud service previously identified. The corresponding microservice of the transformation and communication engine can receive the API call in the universal API format, and can utilize API translation information of a brand-specific API call transformer (e.g. the brand-specific API call transformers 208a-c) to generate a transformed API call in the brand-specific format. The method 400 can then continue at 416 with the calling of the target cloud service with the transformed API call. The calling of the target cloud service at 416 can be performed via a cloud service communicator (e.g., the cloud service communicators 210a-c) of the utilized microservice. The cloud service communicator can interface directly with a cloud provider (e.g., the cloud providers 124). Accordingly, the transforming and calling of the API call at steps 414 and 416 can be facilitated via a single microservice of the transformation and communication engine specially tailored to the target cloud service and cloud provider using a universally formatted API call input.

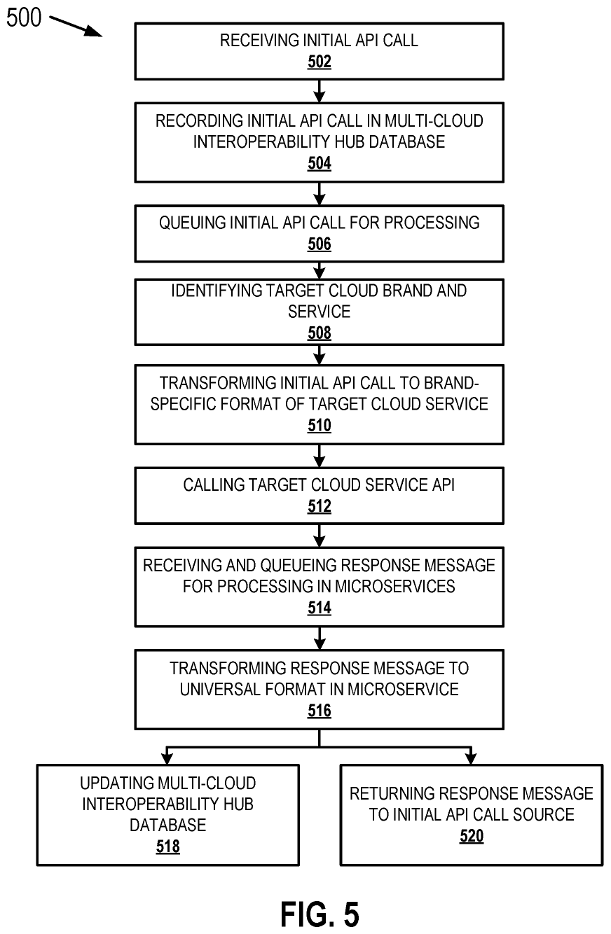

FIG. 5 is an example of a method 500 for communicating an initial API call to a target cloud service and returning an API call response to the source using a universal API format. Method 500 can be implemented by the cloud-connected system 100, as shown in FIG. 1. The method 500, as described herein, can further incorporate one or more components of the method 400 of FIG. 4, without departing from the scope of this disclosure, Thus, reference can be made to the example of FIGS. 1-4 in the example of FIG. 5. Method 500 can begin at 502 by receiving an initial API call within the MCIH from a user device/client application server. In some embodiments the initial API call can be received within a web server, as discussed above, from user device/client application server. However, the initial API call can be alternatively received within a universal API hub from any source for the purposes of method 500. The initial API call can include a desired operation to be performed by a target cloud service, and can identify a target cloud service. The initial API call received at step 502 can be received in a universal API format, such as the universal API format described in FIG. 3, which can provide pertinent information in a universal format for later conversion.

Method 500 can further include recording the initial API call and relevant source information within a database of the MCIH, as described above. The recorded information can be stored as state information relating to the status of the API call's overall transaction, as well as information regarding the source of the initial API call for later returning of a response message.

Method 500 can proceed at step 506 with queucing the initial API call for processing within the transformation and communication engine of the MCIH. The queueing of the initial API call at 506 can be performed as described above, with queues adjusted for priority calls/messages. Following queueing of the initial API call at 506, in some embodiments, the initial API call can be received within the transformation and communication engine for identifying the target cloud brand and target cloud service at step 508. The identification can be performed via the previously stored and flagged information regarding the target cloud service provided by a user device/client application server. Identifying the target cloud service within the transformation and communication engine at 508 can enable forwarding of the initial API call to a desired microservice corresponding to the target cloud service.

The microservice corresponding to the target cloud service can receive the initial API call at step 510, and method 500 can further include transforming the initial API call into a brand-specific format. The transformation performed at 510 can utilize API call translation information provided within the microservice, particularly within a brand-specific API call transformer, and specially generated to enable two-way translations between the universal API format and the brand-specific format. The transformation at 510 can include extracting pertinent information from the initial API call's universal API format, and can reshape the pertinent information into a brand-specific format that the target cloud service can understand.

Method 500 can continue at step 512 with calling the brand-specific cloud service API with the transformed API call. Calling the brand-specific cloud service API can be performed via the cloud communicator of the microservice, as discussed above, such that the microservice can directly interface with the target cloud service.

The target cloud service can receive the transformed API call and perform the desired action, and can further provide a response message to the MCIH or cloud-connected system regarding the transformed API call. Method 500 can continue at step 514 with receiving the response message and queueing the response for processing in the corresponding microservice. In some embodiments, the response message can be directly received by the microservice for immediate processing. In alternate embodiments, however, the response message can be received via the transformation and communication engine, the message queue, or the universal API hub and further provided to the microservices.

Method 500 can continue at step 516 with transforming the received response back to the universal API format within the corresponding microservice. The received response can be provided to the MCIH in a brand-specific format, and can thus be routed back through the corresponding microservice. As discussed above, the brand-specific API call transformer can enable two-way translation of communications with the target cloud service. Accordingly, the translation information included within the corresponding microservice can include instructions on translating response messages into the universal format utilized by the MCIH and cloud-connected system. The transformed response message can be provided back to the universal API hub at steps 518 and 520 for further operations. The method can continue at 518 with updating the MCIH database via the universal API hub to include the response message, and to update the state of the initial API call to include information regarding the response message and any outcome of the API call. The method can further continue at 520 with returning the response message to the source of the initial API call via the universal API hub and any further communication and gateway components between the universal API hub and the source. The source to which the response message should be returned can be extracted from the database of the MCIH during updating of the state information at 518. The user device/client application server can thus receive a response message in a universal format readable by a presentation layer of the web browser or the client application, such that the result of the initial API call can be displayed to the user device/client application server and can facilitate further operations.

### Method for Adding a Microservice

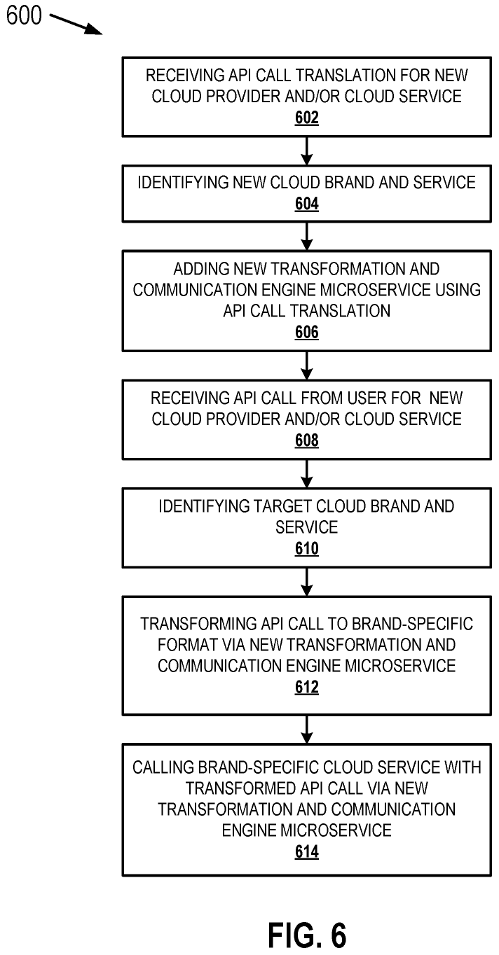

FIG. 6 is an example of a method 600 for adding a new microservice to a transformation and communication engine for further use by users via a universal API format. Method 600 can be implemented by the cloud-connected system 100, as shown in FIG. 1. Thus, reference can be made to the example of FIGS. 1-3 in the example of FIG. 6. Method 600 can begin at 602 by receiving API call translation information for a new cloud provider and/or a new cloud service within a universal API hub from a developer user. The API call translation information for the new cloud provider/service can be held within the universal API hub or database for verification by an administrative user, in the case of an open-source MCIH, or can be accepted within the universal API hub for internal use in a private MCIH. The developer user can be a contributor in an open-source MCIH, an in-house IT professional for a private MCIH, or a cloud brand-side developer for any use case. Method 600 can continue at step 604 with identification of the cloud brand and cloud service for the new API call translation information, such that the information can be tied to a specific use case. Method 600 can then continue at step 606 with adding a new microservice to the transformation and communication engine using the new API call translation information. The new microservice at 606 can be established such that future API calls or response messages are automatically translated and transformed therein for interoperability with the remainder of the MCIH and the cloud-connected system.

Method 600 can continue at step 608 with receiving an API call from a client user (or user device/client application server) for the new cloud provider and/or cloud service. The generated API call from the user device/client application server can include the same universal API call format utilized in previous API calls, such that only the service details can be changed on the client end. The received API call can be identified at step 610 to determine where to route the API call for the target cloud brand and service. Identifying the target cloud brand at 610 can enable routing of the API call to the new microservice established above. Accordingly, method 600 can continue at step 612 with transforming the universally formatted API call to the brand-specific format found in the API Call translation information utilized in generating the new microservice. The transformation and communication engine can include the same structure and operation as described above, however, the new microservice can be added to the previously established microservices for carrying out the transformation and calling to the cloud service (e.g., adding a microservice 206d to FIG. 2). As such, method 600 can continue at step 614 with calling the target cloud service with the transformed API call via the new microservice added to the transformation and communication engine. The remainder of the flow for the API call and the process of returning a response message to the user device/client application server can be performed in a similar manner to methods 400 and 500 of FIGS. 4-5, such that the new microservice can be introduced as a plug and play feature of the MCIH. Method 600 can be performed for any number of new cloud services or cloud brands that are developed or desired after the original creation of the MCIH. As such, the MCIH can continue to evolve and enable a universal language and hub for any cloud service. The universality and simplicity of the front end can enable seamless integration of new services on the client side without requiring additional knowledge or training from an user device/client application server.

From the foregoing, it can be appreciated that specific embodiments of the disclosure have been described herein for purposes of illustration, but that various modifications can be made without deviating from the disclosure. In addition, many of the elements of one embodiment can be combined with other embodiments in addition to or in lieu of the elements of the other embodiments. Accordingly, the technology is not limited except as by the appended claims.

### Further Embodiments and Example Implementations

Specifications, systems and methods for facilitating application integration with cloud services offered by multiple cloud providers are provided. This integration can be achieved through a Multi-Cloud Interoperability Hub (MCIH) that is comprised of a REST API gateway, a transformation and communication engine, asynchronous messaging, and event stream-processing queuing engines and services. The MCIH can enable cloud consuming applications to access (e.g., search, provision, price, manage and/or otherwise utilize) a variety of disparate cloud services in a standardized manner. Additionally, cloud providers can enable access to not yet available in the hub cloud services by adding a service(s) following common data model definitions.

Systems and methods are disclosed for enabling software developers to utilize standardized cloud APIs to access (e.g., provision and/or otherwise utilize or consume) cloud services through their applications, without the need to support multiple individual APIs. The systems and methods are encapsulated in a form of the MCIH, which offers software development organizations (i.e., developer users) an API translation gateway that serves as a universal translation engine from a standardized API call to a cloud brand service specific API call, and can further return the cloud service response in a standardized manner. The developer user can focus on developing the core functionality of the software without the need to spend time figuring out nuances and details of each individual cloud service. Further, the systems and methods provide the developer user with the ability to produce cloud independent software and capitalize on the benefits of new cloud services as soon as they are added to the MCIH. This approach can extend the use of existing and future cloud services, and can provide developer users with the ability to incorporate cloud management functionality in their software without hiring multiple cloud professionals and architects.

In some embodiments, a method is provided for enabling a developer to execute a standardized API call to access, monitor and manage cloud services provided by multiple distinct cloud computing systems. The method can be performed on a system including an API gateway, a queuing engine, and a message transformation and communication engine, capable of performing various services and microservices. The method can include accepting, via an API gateway of a cloud-connected system, an external API call, queuing, via a queucing engine of the cloud-connected system, the external API call for processing, and converting, via a message transformation and communication engine of the cloud-connected system, a message of the external API call into a cloud brand-specific API call format. A response to the cloud brand-specific API call can flow through a same path in an opposite direction, such that the response can be converted reversibly.

The method can further include defining an abstract cloud services object reflecting functional groups of brand-specific cloud services, as defined below, and adding new objects, via a system of abstract cloud services, as further cloud services are developed and offered. As such, the method can enable continuous addition of new cloud services and maintain universality between API call formats. The method can additionally include authenticating an API calling request of a cloud service, via the API gateway, and receiving and accepting, via endpoints requests of the API gateway, information needed to identify a cloud brand, identify a requested service, and provide a brand-specific cloud API with information to perform the requested service. The method can continue through transforming, via the message transformation and communication engine, the external API call into the message of the external API call including metadata needed to form the cloud brand-specific API call for the brand-specific cloud service API, determining a message queue that corresponds to a corresponding abstract object, passing to the message queue, and updating and storing a state of each managed cloud service to be available to the API gateway and to the transformation and communication engine.

The method can further include queuing and managing, via the queuing engine, the message to be processed in asynchronous or synchronous communication means, making a request message or a response message, from the message transformation and communication engine or API gateway, available for processing, and flagging the request message or the response message for brand-specific service processing. In some embodiments, the method can additionally include querying, via microservices of the message transformation and communication engine, one or more message queues to identify a target message for processing, retrieving the target message, preparing a target API call for the brand-specific cloud service, sending the target API call to the brand-specific cloud service API, receiving a response from the brand-specific cloud service API into a corresponding queue, and adding, via the message transformation and communication engine, additional microservices to communicate with a new cloud provider and/or a new cloud service.

In some embodiments, an abstract cloud service object can reflect functional groups of brand-specific cloud services such as: “Instance” representing AMAZON ELASTIC COMPUTE CLOUD (EC2), AMAZON WORKSPACES, AZURE VM, GOOGLE COMPUTE ENGINE, etc.; object “DataSource” representing AMAZON RELATIONAL DATABASE SERVICE (RDS) AND OTHER AWS DATA REPOSITORIES, AZURE DATABASE SERVICES, GOOGLE CLOUD SQL, etc.; object “storage” representing AMAZON SIMPLE STORAGE SERVICE (S3), AZURE STORAGE, GOOGLE CLOUD STORAGE, etc.; and other abstract objects. In some embodiments, an API gateway can receive requests in the form of the RESTful calls accompanied with JSON file that provide information needed to identify cloud brand, identify requested service, and provide brand specific cloud API with information to perform requested function.

What is claimed is:

1. A method of enabling user access of cloud services provided by multiple distinct cloud computing systems, the method comprising:
receiving, via an application programming interface (API) gateway of a cloud-connected system, an initial API call and a target cloud service;
determining, via a universal API hub of the cloud-connected system, brand-specific API formatting for the target cloud service;
transforming, via a transformation and communication engine of the cloud-connected system, the initial API call into a brand-specific API call using the brand-specific API formatting; and
communicating, via the transformation and communication engine, the brand-specific API call to the target cloud service.

2. The method of claim 1, wherein the initial API call is received in a universal API format without brand-specific API formatting.

3. The method of claim 2, further comprising:
receiving, via input of a user device or client application server, a desired cloud operation to be performed on the target cloud service; and
transforming, via the universal API hub of the cloud-connected system, the desired cloud operation into a universal API format.

4. The method of claim 3, wherein the input of the user device or client application server is received via a web browser or a client application on the user device or client application server.

5. The method of claim 1, wherein the initial API call is transformed via one or more microservices of the transformation and communication engine corresponding to the target cloud service.

6. The method of claim 1, wherein the brand-specific API call is communicated via one or more microservices of the transformation and communication engine corresponding to the target cloud service.

7. The method of claim 1, further comprising:
receiving, via the API gateway of the cloud-connected system, one or more further initial API calls to one or more target cloud services; and
passing the initial API call and the one or more further initial API calls to a message queue of the cloud-connected system for processing.

8. The method of claim 1, further comprising:
receiving, via the transformation and communication engine, a response from the target cloud service corresponding to the cloud-brand specific API call;
transforming, via the transformation and communication engine, the response into a universal API formatted response; and
returning the universal API formatted response to a source of the initial API call.

9. The method of claim 8, further comprising:
queueing, via a message queue of the cloud-connected system, the universal API formatted response for processing, wherein the universal API formatted response is queued for processing along with further API calls or further responses.

10. The method of claim 8, further comprising:
storing the initial API call in an entry of a database of the cloud-connected system; and
updating the entry of the database to include the universal API formatted response corresponding to the initial API call.

11. A cloud-connected system for accessing cloud services provided by multiple distinct cloud computing systems, the cloud-connected system comprising:
a processor;
a storage device communicatively coupled to the processor, wherein the storage device is configured to store computer-executable instructions, which, when executed by a processor, cause the processor to:
receive, via a web server, one or more initial application programming interface (API) calls and one or more target cloud services from one or more user devices or client application servers;
pass the initial API calls from the web server to an API gateway;
transform, via a transformation and communication engine, the initial API calls into brand-specific formats of the target cloud services;
store the one or more transformed API calls in an entry of a database in communication with the universal API hub; and
call, via the transformation and communication engine, the target cloud services using the transformed API calls.

12. The cloud-connected system of claim 11, wherein the computer-executable instruction cause the processor to further:
queue, via a queueing engine of the universal API hub, the initial API calls for transformation; and
communicate, via one or more microservices of the transformation and communication engine, the transformed API calls to the target cloud services.

13. The cloud-connected system of claim 12, wherein the computer-executable instruction cause the processor to further:
receive, via the transformation and communication engine, one or more responses to the transformed API calls from the target cloud services; and
queue, via the queuing engine, the responses from the target cloud services for transformation.

14. The cloud-connected system of claim 13, wherein the computer-executable instruction cause the processor to further:
transform, via the one or more microservices of the transformation and communication engine, the responses into a universal API format.

15. The cloud-connected system of claim 14, wherein the computer-executable instruction cause the processor to further:
update the entry of the database of the transformed API calls to include the transformed responses from the target cloud services.

16. The cloud-connected system of claim 14, wherein the computer-executable instruction cause the processor to further:
queue, within a message queue, a message including the transformed responses to be returned to the API gateway.

17. The cloud-connected system of claim 16, wherein the computer-executable instruction cause the processor to further:
provide, via the web server, the message including the transformed responses from the API gateway to the user devices or client application servers.

18. A method of adding further microservices to a cloud-connected system for accessing cloud services provided by multiple distinct cloud computing systems, the method comprising:
receiving, from a developer user, API call translation information for a new cloud provider and/or a new cloud service of an existing cloud provider;
identifying, via the cloud-connected system, the cloud brand and the cloud service of the API call translation information; and
establishing a new microservice of a transformation and communication engine for the cloud service with instructions for transformation of API calls using the API call translation information.

19. The method of claim 18, further comprising:
receiving, from a user device or client application server, an initial API call and a target cloud service, wherein the target cloud service corresponds to the new microservice;
transforming, via the new microservice of the transformation and communication engine, the initial API call into a brand-specific API call using the API call translation information;
communicating, via the new microservice of the transformation and communication engine, the brand-specific API call to the target cloud service.

20. The method of claim 19, further comprising:
receiving, via the new microservice of the transformation and communication engine, a response from the target cloud service corresponding to the cloud-brand specific API call;
transforming, via the new microservice of the transformation and communication engine, the response into a universal API formatted response using the API call translation information; and
returning the universal API formatted response to the user device or client application server.
